(19) United States
(12) Patent Application Publication
(10) Pub. No.: US 2026/0175641 A1
(43) Pub. Date: Jun. 25, 2026

(54) VEHICLE AND METHOD OF CONTROLLING THE SAME

(71) Applicants: Hyundai Motor Company, Seoul (KR); Kia Corporation, Seoul (KR)

(72) Inventors: Lei Gong, Yantai (CN); Guo Feng Jin, Yantai (CN); Xu Qiang Sun, Yantai (CN); Jian Kang Man, Yantai (CN); Hui Xie, Yantai (CN); Jin Shun Li, Yantai (CN)

(21) Appl. No.: 19/319,488

(22) Filed: Sep. 4, 2025

(30) Foreign Application Priority Data
Dec. 19, 2024 (CN) 202411884014.4

(51) Int. Cl. B60H 1/00; B60L 1/00

(52) U.S. Cl. CPC B60H 1/00764; B60H 1/00392; B60L 1/003; B60L 2250/16

(57) ABSTRACT

A vehicle and a method of controlling the same are disclosed. A vehicle according to an aspect is a vehicle of an electric charging type and may include an input/output interface and a processor configured to receive a target driving distance of the vehicle through the input/output interface, compare the target driving distance with a distance to empty (DTE) of the vehicle to determine a necessity of changing an operating intensity of an air conditioning device of the vehicle, and output a determined result through the input/output interface.

### CROSS-REFERENCE TO RELATED APPLICATION

This application claims priority to and the benefit of Chinese Patent Application No. 202411884014.4, filed on Dec. 19, 2024, the disclosure of which is incorporated herein by reference in its entirety.

### TECHNICAL FIELD

Various aspects of the present disclosure relate to techniques for controlling energy in electric vehicles.

### BACKGROUND

The matters described in this Background section are only for enhancement of understanding of the background of the disclosure, and should not be taken as acknowledgment that they correspond to prior art already known to those skilled in the art.

Technology for minimizing the consumption of energy resources in electric vehicles can be performed by adjusting driving and braking torque.

However, there are limits to saving energy by varying driving and braking torque in electric vehicles. In particular, energy-saving technology that is more efficient than the driving and braking torque of electric vehicles may be needed to reach a target driving distance intended by a driver.

Meanwhile, in the total energy used in electric vehicles, excluding the energy required for general driving, the largest amount of energy may be used for cooling and heating of an air conditioning device.

### SUMMARY

The following summary presents a simplified summary of certain features. The summary is not an extensive overview and is not intended to identify key or critical elements.

Aspects of the disclosure solve the aforementioned problems, and is directed to controlling an air conditioning device of a vehicle to save energy of an electric vehicle and thereby extend a distance to empty (DTE).

Problems to be solved by the present invention are not limited to those mentioned above, and other problems not mentioned will be clearly understood by those of ordinary skill in the art from the following description.

A vehicle may comprise: a battery; a motor configured to receive power from the battery; an air conditioner configured to receive power from the battery; a user interface; a processor; and a memory storing at least one instruction, wherein the at least one instruction, executed by the processor, is configured to cause the vehicle to: determine, based on a user input received via the user interface, a target driving distance of the vehicle, wherein the user input indicates a destination of the vehicle, identify a distance to empty (DTE) of the vehicle, compare the target driving distance with the DTE of the vehicle, change, based on the comparison of the target driving distance with the DTE of the vehicle, an operating intensity of the air conditioner, and output, via the user interface, an indication of the changed operating intensity.

The at least one instruction, executed by the processor, may be configured to cause the vehicle to change the operating intensity based on at least one of: a minimum rotational speed, of the air conditioner, associated with characteristics of the air conditioner; the target driving distance; the DTE; or a current rotational speed of the air conditioner.

The at least one instruction, executed by the processor, may be configured to cause the vehicle to determine a reduction in the operating intensity based on: the DTE being equal to or greater than a first value, a difference between the target driving distance and the DTE being less than a second value, and the current rotational speed of the air conditioner being greater than the minimum rotational speed.

The at least one instruction, executed by the processor, may be configured to cause the vehicle to: reduce the operating intensity of the air conditioner by a first output and calculate a first additional driving distance according to the reduction by the first output; and output, based on a difference between the first additional driving distance and the target driving distance being equal to or greater than a third value, a request for reducing the operating intensity by the first output via the user interface.

The at least one instruction, executed by the processor, may be configured to cause the vehicle to: reduce the operating intensity of the air conditioner by a first output and calculate a first additional driving distance according to the reduction by the first output; based on a difference between the first additional driving distance and the target driving distance being less than a third value, reduce the operating intensity of the air conditioner by a second output and calculate a second additional driving distance according to the reduction by the second output, wherein the second output is greater than the first output; and output, based on a difference between the second additional driving distance and the target driving distance being equal to or greater than the third value, a request for reducing the operating intensity by the second output via the user interface.

The at least one instruction, executed by the processor, may be configured to cause the vehicle to output, based on the current rotational speed of the air conditioner being equal to the minimum rotational speed, a request to turn off the air conditioner via the user interface.

The at least one instruction, executed by the processor, may be configured to cause the vehicle to output, based on the current rotational speed of the air conditioner not being detected, a request to charge the vehicle via the user interface.

The at least one instruction, executed by the processor, may be configured to cause the vehicle to reduce the current rotational speed of the air conditioner in response to a user input requesting a change in the operating intensity or automatically reduce the current rotational speed of the air conditioner.

The at least one instruction, executed by the processor, may be configured to cause the vehicle to reduce the current rotational speed of the air conditioner to the minimum rotational speed.

The vehicle may further comprise at least one sensor. The at least one instruction, executed by the processor, may be configured to cause the vehicle to determine the target driving distance of the vehicle further based on a location of the vehicle detected via the at least one sensor, wherein the at least one instruction, executed by the processor, is configured to cause the vehicle to identify, based on a state of charge (SOC) of the battery, the DTE, and wherein the at least one instruction, executed by the processor, is configured to cause the vehicle to output, via the user interface, an indicator of the target driving distance and an indicator of the DTE that is visually distinguished from the indicator of the target driving distance.

A vehicle comprising: at least one sensor; a battery; a motor configured to receive power from the battery; an air conditioner configured to receive power from the battery; a user interface; a processor; and a memory storing at least one instruction, wherein the at least one instruction, executed by the processor, is configured to cause the vehicle to: determine, based on a location of the vehicle detected via the at least one sensor and based on a user input received via the user interface, a target driving distance of the vehicle, wherein the user input indicates a destination of the vehicle, identify, based on a state of charge (SOC) of the battery, a distance to empty (DTE) of the vehicle, compare the target driving distance with the DTE of the vehicle, and change, based on the comparison of the target driving distance with the DTE of the vehicle, an operating intensity of the air conditioner by sending a control signal to the air conditioner.

A method performed by a vehicle may comprise: determining, based on a location of the vehicle detected via at least one sensor of the vehicle and based on a user input received via a user interface of the vehicle, a target driving distance of the vehicle; identifying, based on a state of charge (SOC) of a battery of the vehicle, a distance to empty (DTE) of the vehicle; comparing the target driving distance with the DTE of the vehicle; changing, based on the comparing of the target driving distance with the DTE of the vehicle, an operating intensity of an air conditioner of the vehicle by sending a control signal to the air conditioner; and outputting, via the user interface, an indication of the changed operating intensity.

The method may perform one or more operations and/or may implement one or more features described herein.

A non-transitory computer-readable medium may store at least one instruction, when executed by a processor, that is configured to cause one or more operations described herein.

These and other features and advantages are described in greater detail below.

### BRIEF DESCRIPTION OF THE DRAWINGS

The above and other objects, features and advantages will become more apparent to those of ordinary skill in the art by describing exemplary aspects thereof in detail with reference to the accompanying drawings, in which:

FIG. 1 illustrates an example configuration diagram of a vehicle according to an aspect;

FIG. 2 is an example flowchart of an operation for controlling an air conditioning device in a control device according to an aspect;

FIG. 3 is an example flowchart of an operation for determining the necessity of changing a driving output of the air conditioning device in the control device according to an aspect;

FIG. 4 is a specific flowchart of an operation for controlling the air conditioning device in the control device according to an aspect; and

FIG. 5 shows example parameter result values of an air conditioning device compressor according to an aspect.

### DETAILED DESCRIPTION

Hereinafter, preferred aspects of the present disclosure will be described in detail with reference to the accompanying drawings.

However, the technical idea of the present disclosure is not limited to some aspects to be described but may be implemented in various different forms, and within the scope of the technical idea of the present invention, one or more among components in the aspects may be used by being selectively combined and substituted.

Further, unless specifically defined and described, terms used in the aspects of the present disclosure (including technical and scientific terms) may be interpreted as meanings which are generally understood by those skilled in the art to which the present invention pertains, and commonly used terms such as terms defined in dictionaries may be interpreted in consideration of the contextual meaning of the related art.

The terms used in the aspects of the present disclosure are for the purpose of describing the aspects only and are not intended to limit the invention.

According to one or more aspects described herein, a vehicle and a method for controlling the vehicle are disclosed. In some examples, the vehicle is of an electric charging type (e.g., an electric vehicle), and the vehicle may include one or more processors, memory that stores instructions that are executed by the one or more processors, and an input/output device. In an aspect, a processor may be configured to receive a target driving distance of the vehicle through the input/output interface, which may also be stored in the memory. In another aspect, the target driving distance may be compared with a distance to empty (DTE) of the vehicle to determine a necessity of changing an operating intensity of the air conditioning device by adjusting power of a compressor associated with the air conditioning device. In another aspect, a determined result associated with the comparing may be outputted through the input/output interface.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present invention, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

The expression “driving output of an air conditioning device” may be interpreted to mean “the operating intensity of the air conditioning device.” In addition, the driving output or operating intensity of the air conditioning device may be changed, for example, by controlling the output of at least one component (e.g., a compressor, a fan motor, an inverter, or the like) that constitutes the air conditioning device. For example, the driving output or operating intensity of the air conditioning device may be changed by controlling a refrigerant flow of the air conditioning device, changing a rotational speed of the motor, or changing the frequency of the inverter.

In the various flowcharts described herein, at least some of operations may be omitted or their order may be changed, and at least some of the various aspects may be performed at specific points in each operation of the flowchart. Various flowcharts of the present document may be performed by at least one of a control device 100, a processor 130, a control unit, or a computer program, as discussed in more detail below. In the various flowcharts described herein, any content that overlaps the content of previously described flowcharts may be omitted.

Hereinafter, aspects will be described in detail with reference to the accompanying drawings, but the same or corresponding components are denoted by the same reference numerals regardless of the drawing numbers, and redundant descriptions thereof will be omitted.

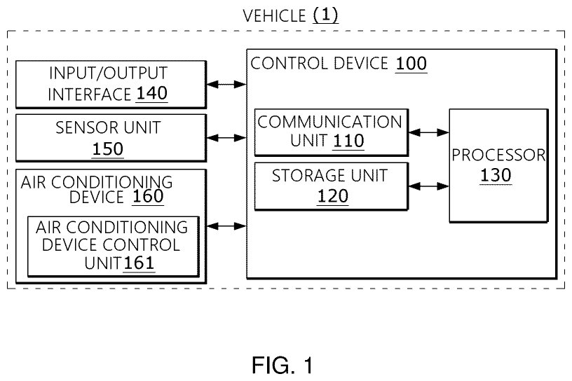

FIG. 1 illustrates an example configuration diagram of a vehicle 1 according to an aspect.

The vehicle 1 may include a control device 100, a communication unit 110, a storage unit 120, a processor 130, an input/output interface 140, a sensor unit 150, an air conditioning device 160, and an air conditioning device control unit 161. Each of the components in FIG. 1 may be implemented inside the vehicle 1. In some cases, vehicle 1 may be a vehicle of an electric charging type and, although not illustrated, may include a power source (e.g., a battery) therein.

The control device 100 is a device or program that may perform the function of checking a distance to empty (DTE) of the vehicle 1, receiving a target driving distance, and changing the driving output of the air conditioning device when a predetermined condition is met, and/or perform other functions.

The control device 100 may be formed integrally with internal components of the vehicle, or may be implemented as a separate device and connected to the internal components of the vehicle by a separate connecting device. For example, the control device 100 is illustrated as including the communication unit 110, the storage unit 120, and the processor 130, but may also be configured to include other components of the vehicle 1 (e.g., the input/output interface 140 and the like).

The communication unit 110 (e.g., a communication interface, a communication modem, a transceiver, and/or a combination thereof, etc.) may communicate with a user terminal, another vehicle, an external server, or the like. The communication unit 110 may perform short range communication, global positioning system (GPS) signal reception, vehicle-to-everything (V2X) communication, optical communication, broadcast transmission and reception, and intelligent transport systems (ITS) communication functions. The communication unit 110 may support short range communication using at least one of Bluetooth, radio frequency identification (RFID), Infrared Data Association (IrDA), ultra wideband (UWB), ZigBee, near field communication (NFC), Wireless-Fidelity (Wi-Fi), Wi-Fi Direct, and wireless Universal Serial Bus (wireless USB) technologies. The communication unit 110 may include a mobile communication module using a mobile communication network and a wireless Internet module for wireless Internet access.

The storage unit 120 may include instructions related to operating an energy saving mode through changes in the driving output of the air conditioning device. The storage unit 120 may include a memory. The storage unit 120 may be provided inside the processor 130 or the control device 100, or may be a separate memory. The storage unit 120 may be constituted by a combination of a non-volatile memory such as a hard disk drive, flash memory, electrically erasable programmable read-only memory (EEPROM), static RAM (SRAM), ferro-electric RAM (FRAM), phase-change RAM (PRAM), magnetic RAM (MRAM), or the like, and/or a volatile memory such as a dynamic random access memory (DRAM), synchronous dynamic random access memory (SDRAM), double date rate-SDRAM (DDR-SDRAM), or the like.

The processor 130 may be electrically or operatively connected to the communication unit 110, the storage unit 120, the input/output interface 140, the sensor unit 150, the air conditioning device 160, the air conditioning device control unit 161, and various internal components of the vehicle 1, may electrically control each component, and may be an electric circuit that executes software commands, thereby performing various data processing and calculations described below.

The processor 130 may process a signal transmitted between each component of the vehicle 1, and may perform overall control so that each component may normally perform its respective functions. The processor 130 may be implemented in the form of hardware, in the form of software, or in the form of a combination of hardware and software. In addition, the control device 100 may include at least one processor 130.

The input/output interface 140 may include an input unit for receiving a control command from the user and an output unit for outputting an operation state, result, and the like, of the control device 100. Here, the input unit may include physical keys (e.g., physical buttons) and soft keys implemented on a touch display.

The output unit may include a display, and may further include a voice output device such as a speaker, and a haptic module that may, for example, generate vibration. In this case, when a touch sensor such as a touch film, a touch sheet, a touch pad, or the like, is provided on the display, the display may operate as a touch screen, and may be implemented in a form in which the input unit and the output unit are integrated.

The input/output interface 140 may be implemented as a physical button, a display, a head-up display (HUD), a cluster, an audio video navigation (AVN), a human machine interface (HMI), a user setting menu (USM), or the like. In addition, the display may be included in a rear view mirror or a side mirror.

For example, the user may request operations and displays related to the driver engagement state evaluation and the autonomous driving-related function control through physical buttons of the cluster or a display of the AVN as the input unit. In addition, the vehicle 1 may receive input or output a screen through a display on a console positioned in a second or third row of the vehicle, or through a display of an application implemented on a user terminal.

The sensor unit 150 may include at least one of a radio detection and ranging (RADAR) sensor, a light imaging detection and ranging (LIDAR) sensor, a fingerprint recognition sensor, a retina recognition sensor, an iris recognition sensor, a camera, a steering wheel grip sensor, a pressure sensor, a position sensor (e.g., GPS and the like), an ultrasonic sensor, a heart rate sensor, a light sensor, a pressure-sensitive sensor, a motion sensor, a seating sensor, and an infrared sensor. The camera may include an exterior camera for monitoring the exterior of the vehicle and an interior camera for detecting an object, such as a driver, inside the vehicle.

The sensor unit 150 may check a state of the battery. For example, the sensor unit 150 may include a voltage sensor, a temperature sensor, a current sensor, a state of charge monitoring sensor (SOC sensor), an internal resistance sensor, and the like, to monitor a charging state of the battery. When the charging state of the battery in the electric vehicle is detected through the sensor unit 150, the processor 130 may calculate the DTE of the vehicle 1 through the detected data.

The air conditioning device 160 may include an air conditioner and a heater. The air conditioning device 160 may control an interior temperature of the vehicle 1.

The air conditioning device 160 may include a compressor. The compressor may adjust output (power) in the air conditioning system of the vehicle to adjust the cooling and heating performance. The compressor compresses a refrigerant to increase the temperature and pressure, and the refrigerant for adjusting the interior temperature of the vehicle is circulated through the compressor. The compressor may include a drive motor that drives the compressor and the refrigerant that may periodically circulate within the compressor.

As a rotational speed of the compressor increases, the driving output may also increase. In addition, as the rotational speed of the compressor increases, the energy consumed by the compressor may also increase. In an aspect, controlling the driving output of the air conditioning device 160 may be interpreted as controlling the driving output of the compressor included in the air conditioning device 160.

In an aspect, the rotational speed of the compressor included in the air conditioning device 160 may be detected through at least one of the air conditioning device 160, the air conditioning device control unit 161, and the sensor unit 150 and transmitted to the control device 100. To this end, the sensor unit 150 may detect the rotational speed of the compressor through, for example, a Hall sensor or an optical sensor, a current measurement sensor or a pulse width modulation (PWM) signal.

The processor 130 may transmit a control signal to the air conditioning device control unit 161. For example, the processor 130 may transmit a signal to the air conditioning device control unit 161 to perform control to change the rotational speed or driving output of the compressor of the air conditioning device 160.

The air conditioning device control unit 161 may control the air conditioning device 160 based on the control signal transmitted from the processor 130.

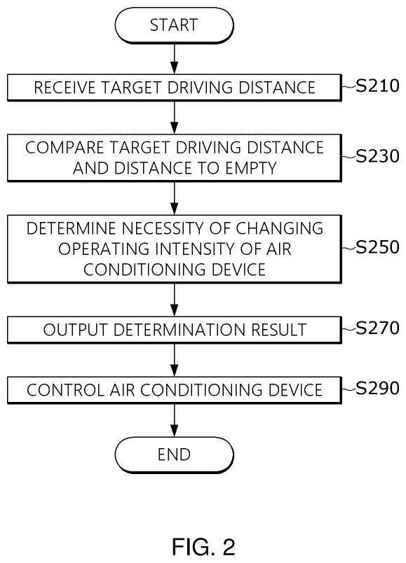

FIG. 2 is an example flowchart of an operation for controlling the air conditioning device 160 in the control device according to an aspect.

The control device 100 may receive a target driving distance (S210).

For example, the processor 130 may receive a specific destination or a specific target driving distance from a user through the input/output interface 140.

According to an aspect, the processor 130 may display a speed prediction adjustment screen through the input/output interface 140 such as a display. Through the speed prediction adjustment screen, a driver or others may execute an energy saving mode as described herein.

The energy saving mode may be a control mode for reducing the dynamic output of the compressor of the air conditioning device 160 to extend the DTE. The driver and others may make a selection input on the speed prediction adjustment screen as to whether to enable the energy saving mode. In this case, the driver and others may input a target driving distance. The processor 130 may display the input target driving distance through the input/output interface 140.

The control device 100 may compare the target driving distance and the DTE (S230).

In some cases, to calculate the DTE, the processor 130 may check the charging state of the battery through the sensor unit 150 and calculate the DTE based on the checked charging state of the battery.

For example, the processor 130 may calculate the DTE based on at least one of a remaining state of charge (SOC) of the battery, average energy consumption per distance Pa of the vehicle, and an average speed V of the vehicle. For example, the DTE Sᵣ may be calculated as SOC/Pa.

The processor 130 may compare the calculated DTE with the target driving distance input by the user. In addition, to determine the necessity of changing the driving output, the processor 130 may check a minimum rotational speed and a current rotational speed of the compressor of the air conditioning device 160.

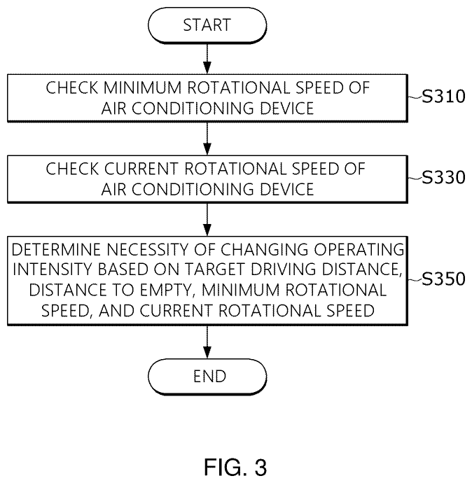

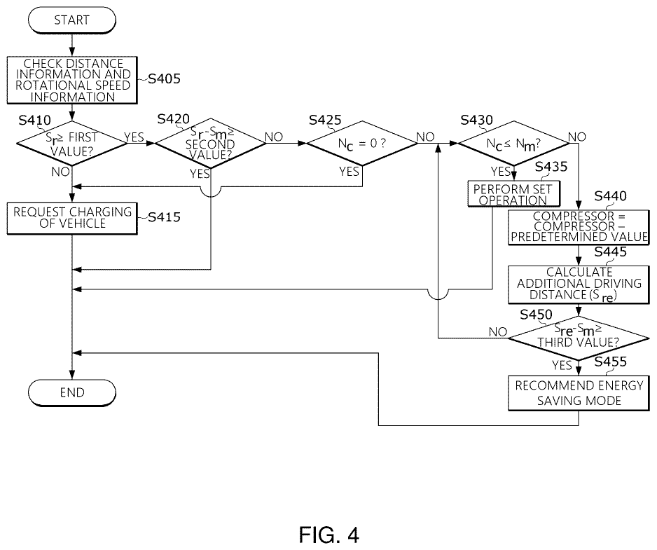

The control device 100 may determine the necessity of changing the driving output of the air conditioning device 160 based on the input or checked contents. The determination of the necessity of changing the driving output is described in more detail with respect to FIGS. 3 and 4.

Next, the control device 100 may output a determination result (S270).

For example, the processor 130 may output the necessity of changing the driving output of the air conditioning device 160 determined in operation S250 and the information checked for determination, for example, the DTE, the target driving distance, the minimum rotational speed of the compressor of the air conditioning device 160, the current rotational speed, and the like, through the input/output interface 140.

In addition, the processor 130 may display a current operating state of the vehicle 1 and output a control method required for the vehicle to arrive at the destination to the driver. For example, the processor 130 may output the content indicating that the vehicle 1 is driven or may be driven in the energy saving mode through the input/output interface 140.

According to an aspect, the processor 130 may display at least one of the target driving distance and the DTE through the input/output interface 140 to be distinguished from each other. In addition, the processor 130 may display information indicating that the changing of the driving output is required and the information checked for determination to be distinguished from each other. The processor 130 may display at least one of the DTE, the target driving distance, the minimum rotational speed of the compressor of the air conditioning device 160, and the current rotational speed to be distinguished from each other.

Next, the control device 100 may control the air conditioning device 160 (S290).

For example, the processor 130 may transmit a signal requesting control of the air conditioning device 160 according to the energy saving mode to the air conditioning device control unit 161, and the air conditioning device control unit 161 may control a setting output of the air conditioning device compressor (e.g., an air conditioner compressor) in response to this request. In this way, the energy of the vehicle 1 may be saved.

The control of the air conditioning device 160 according to the energy saving mode may be manually performed by the user or may be automatically performed when a certain condition is met. For example, in a situation where the energy saving mode is possible, the air conditioning device 160 may be preset so that the driving output thereof is automatically reduced.

FIG. 3 is an example flowchart of an operation for determining the necessity of changing the driving output of the air conditioning device 160 in the control device 100 according to an aspect.

The control device 100 may check a minimum rotational speed Nm corresponding to the air conditioning device 160 (S310).

The minimum rotational speed Nm may be a value determined according to the system balance of the air conditioning device 160 and the characteristics of the compressor itself. In some implementations, in the compressor, a minimum rotational speed may be set, and an air conditioner system may require the minimum rotational speed of the compressor to maintain balance. The maximum of the two values may be determined as the minimum rotational speed Nm, but is not limited thereto, and the minimum rotational speed Nm may be determined according to preset policies or the like.

Next, the control device 100 may check a current rotational speed of the air conditioning device 160 (S330).

For example, the processor 130 may check the current rotational speed of the compressor of the air conditioning device 160 through the air conditioning device control unit 161 or the sensor unit 150 based on a point in time point where the target driving distance is input by the user or every specific cycle.

Next, the control device 100 may determine the necessity of changing the driving output of the air conditioning device 160 based on at least one of the target driving distance, the DTE, the minimum rotational speed, and the current rotational speed (S350).

FIG. 4 is a specific flowchart of an operation for controlling the air conditioning device 160 in the control device 100 according to an aspect.

The control device 100 may check distance information and rotational speed information (S405). The processor 130 may check a target driving distance Sₘ input by the user, the DTE Sᵣ of the vehicle 1, a current rotational speed Nc, and the minimum rotational speed Nm of the compressor of the air conditioning device 160. In addition, the processor 130 may check a current driving output of the air conditioning device 160. “Current” may refer to a point in time at which the processor 130 receives the target driving distance Sₘ through a user input or at any time interval.

Next, the control device 100 may determine whether the DTE Sᵣ of the vehicle 1 is equal to or greater than a first value (S410). The first value may be a value that takes into account vehicle deviations due to road conditions, temperature, and the like. For example, the first value may be set to 20 km, but is not limited thereto.

For example, when the DTE Sᵣ is less than the first value (“NO” in S410), the processor 130 may output a notification requesting electric charging of the vehicle 1 (S415). This is because the current DTE Sᵣ may be too short, so even when the vehicle is driven in the energy saving mode, it is not possible for the vehicle to reach the target driving distance.

In some cases, when the DTE Sᵣ is equal to or greater than the first value (“YES” in S410), the control device 100 may check whether the difference between the DTE Sᵣ and the target driving distance Sₘ is equal to or greater than a second value (S420). For example, the processor 130 may determine whether a value obtained by reducing the target driving distance Sₘ from the DTE Sᵣ is equal to or greater than the second value. Here, the second value may be equal to or different from the first value.

When the difference between the DTE Sᵣ and the target driving distance Sₘ is equal to greater than the second value (“YES” in S420), the operation of FIG. 4 may be terminated. This is because the current DTE Sᵣ is sufficiently greater than the target driving distance Sₘ, so there is no need for the vehicle 1 to be driven in the energy saving mode. In this case, although not illustrated, the control device 100 may transmit a control signal to the compressor so that the compressor output of the air conditioning device 160 may be further increased. For example, the processor 130 may output that the driving output of the air conditioning device 160 such as the air conditioner or the like may be further increased through the input/output interface 140.

For example, when the difference between the DTE Sᵣ and the target driving distance Sₘ is less than the second value (“NO” in S420), the control device 100 may check whether the current rotational speed Nc of the compressor of the air conditioning device 160 is 0 (S425). For example, the processor 130 may check whether the air conditioning device 160 is currently turned off.

If the air conditioning device 160 is turned off (“YES” in S425), that is, when the current rotational speed of the air conditioning device 160 is not detected, the control device 100 may request charging of the vehicle (S415). In this situation, since the difference between the DTE Sᵣ and the target driving distance Sₘ is not large, the driving of the energy saving mode is required to some extent, but since the air conditioning device 160 is turned off, it may be practically difficult to operate the energy saving mode. The processor 130 may also indicate that there is no energy saving mode to select through the input/output interface 140. In addition, the processor 130 may output an indication requesting charging of the vehicle through the input/output interface 140.

The processor 130 may request vehicle charging in a manner distinct from requesting charging of the vehicle when the aforementioned DTE Sᵣ is less than the first value. For example, the processor may indicate that charging of the vehicle is optional rather than mandatory.

If the air conditioning device 160 is turned on (“NO” in S425), the control device 100 may determine whether the current rotational speed Nc of the air conditioning device 160 is less than or equal to the minimum rotational speed Nm of the air conditioning device 160 (S430).

If the current rotational speed Nc of the air conditioning device 160 is less than or equal to the minimum rotational speed Nm of the air conditioning device 160 (YES in S430), the control device 100 may perform a preset operation (S435). This situation is a situation where driving of the energy saving mode may be necessary since the difference between the DTE Sᵣ and the target driving distance Sₘ is not large, but the driving of the energy saving mode is not performed.

In this case, the current rotational speed Nc of the air conditioning device 160 may be determined by being divided into a case of being less than the minimum rotational speed Nm and a case of being the same as the minimum rotational speed Nm.

If the current rotational speed Nc of the air conditioning device 160 is less than the minimum rotational speed Nm, no specific control operation may be performed or a request for charging of the vehicle may be output.

In some cases, if the rotational speed Nc of the air conditioning device 160 is equal to the minimum rotational speed Nm, the processor 130 may output a turn-off request of the air conditioning device 160 through the input/output interface 140.

Next, if the current rotational speed Nc of the air conditioning device 160 exceeds the minimum rotational speed Nm of the air conditioning device 160 (“NO” in S430), the control device 100 may determine to reduce the output of the compressor of the air conditioning device 160 (S440). That is, the rotational speed reduced by a predetermined value from the current rotational speed of the compressor may be considered as an element in a process of determining the energy saving mode.

This operation may be a control in which the control device 100 actually reduces the output of the air conditioning device 160, but may also be a simulation process for determination. That is, the operation may be a prior determining process to determine the necessity of the energy saving mode. For example, assuming that the output of the air conditioning device 160 is reduced by a specific output (e.g., a first output), the processor 130 may calculate an additional driving distance Sᵣₑ according to the reduction by the specific output (e.g., the first output) (S445). In this case, the additional driving distance Sᵣₑ may be, for example, a first additional driving distance.

According to an aspect, the calculation of the additional driving distance may be calculated by the following equation, but is not limited thereto and the driving distance may be calculated by various methods.

Sᵣₑ=SOC/(Pa−(Pi/V))

Sᵣₑ may be an additional driving distance, SOC may be a charge amount of the battery (e.g., the unit may be kWh), Pa may be an average power consumption per 1 km of the vehicle (e.g., the unit may be kWh/km), Pi may be the output saved from the compressor after the rotational speed conversion (e.g., the unit may be kW), V may be an average speed of the vehicle (e.g., the unit may be km/h). In this case, the average speed of the vehicle may be an average speed over a predetermined period of time (e.g., 5 minutes), but is not limited thereto.

In addition, the current rotational speed NC of the air conditioning device 160 may be also simulated as being lowered by a predetermined value according to the output reduction by the first output.

The control device 100 may determine whether a value obtained by subtracting the target driving distance Sₘ from the calculated first additional driving distance is equal to or greater than a third value (S450). The third value may be the same as or different from the first and second values described above.

If it is determined that the value obtained by subtracting the target driving distance Sₘ from the calculated first additional driving distance is equal to or greater than to the third value (YES in S450), the control device 100 may recommend the energy saving mode based on the calculated values to the driver (S455). For example, the processor 130 may reduce the output of the air conditioning device 160 by the first output, and accordingly output that a distance equivalent to the first additional driving distance may be secured to the driver or others through the input/output interface 140. In this case, the processor 130 may generate a message for the driver or others that the air conditioning device may operate in the energy saving mode corresponding to the first output and the first additional driving distance.

If it is determined that the value obtained by subtracting the target driving distance Sₘ from the calculated first additional driving distance is less than the third value (“NO” in S450), operation S430 may be performed again. In this case, since a situation where the output of the compressor has been reduced by the first output is assumed, it may be assumed that the current rotational speed Nc has also been somewhat reduced.

However, when the current rotational speed Nc of the air conditioning device 160 still exceeds the minimum rotational speed Nm of the air conditioning device 160 (“NO” in S430), the control device 100 may determine to further reduce the output of the compressor of the air conditioning device 160 by one step (S440). For example, the processor 130 may reduce the driving output of the air conditioning device 160 by a second output greater than the first output, and calculate a second additional driving distance according to the reduction by the second output.

If it is determined that a difference between the additionally calculated second additional driving distance and the target driving distance is equal to or greater than the third value, the processor 130 may reduce the output of the air conditioning device 160 by the second output, and output that a distance equivalent to the second additional driving distance may be secured to the driver or others through the input/output interface 140. In this case, the processor 130 may generate a message for the driver or others that the air conditioning device may operate in the energy saving mode corresponding to the second output and the second additional driving distance.

According to an aspect, the rotational speed of the air conditioning device 160 may be reduced to the minimum rotational speed. In various aspects, the method of reducing the rotational speed may reduce the current rotational speed in a stepwise manner as described above, but it is also possible to directly reduce the current rotational speed to the minimum rotational speed.

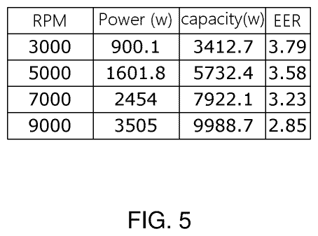

FIG. 5 shows example parameter result values of an air conditioning device compressor according to an aspect. In FIG. 5, RPM stands for Revolution Per Minute (that is, rotational speed) and EER stands for Energy Efficiency Ratio. If the current speed of the vehicle is 50 km/h, the average energy consumption of the vehicle while traveling is assumed to be 0.12 kWh/km and the current charge amount (SOC) of the vehicle is assumed to be 10 kWh. The air conditioning device compressor may be assumed to be an air conditioner compressor.

The power of the compressor may range from 0.9 kW to 3.5 kW, and thus the cooling capacity of the compressor may be in the range of 3.4 kW to 10.0 kW.

Referring to FIG. 5, when the rotational speed of the compressor is adjusted from 5,000 r/min to 3,000 r/min, the power of the compressor is adjusted from 1.6 kW to 0.9 kW. A reduction width of the consumed output is 0.7 kW.

According to the equation Sᵣ−SOC/Pa, when the existing DTE Sᵣ is calculated, it turns out that Sᵣ=10/0.12=83.3 km.

Next, when an additional DTE is calculated according to the equation Sᵣₑ=SOC/(Pa−(Pi/V)), it turns out that Sᵣₑ=10/(0.12−(0.7/50))=94.3 km. In this way, it can be easily confirmed that the DTE has increased by about 11 km.

When the rotational speed of the air conditioner compressor is adjusted from 7000 r/min to 3000 r/min, the compressor power is adjusted from 2.45 kW to 0.9 kW, and the reduced consumed output is 1.55 kW.

According to the equation Sᵣ=SOC/Pa, when the existing DTE Sᵣ is calculated, it turns out that Sᵣ=10/0.12=83.3 km.

Next, when the additional DTE according to the equation Sᵣₑ=SOC/(Pa−(Pi/V)) is calculated, it turns out that Sᵣₑ=10/(0.12−(1.55/50))=112.4 km. In this way, it can be easily confirmed that the driving distance has increased by about 29 km.

As a result of data analysis such as FIG. 5, the rotational speed of the compressor may be adjusted according to demand to reduce energy consumption and increase the driving distance.

By the above-described aspects, energy distribution of the air conditioning system of the vehicle may be controlled according to the actual usage demand of the vehicle to save energy, so that the driving distance may be improved. In addition, the present disclosure may save energy of the vehicle by controlling the driving output of the compressor.

The term “˜unit” used in the present disclosure refers to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

According to an aspect of the present disclosure, by varying a driving output (e.g., operating intensity) of an air conditioning device of an electric vehicle based on a target driving distance, a distance to empty (DTE) can be extended so that a driver can reach the target driving distance intended by the driver.

Effects of the present disclosure are not limited to those mentioned above, and other effects not mentioned will be clearly understood by those of ordinary skill in the art from the description below.

Although preferred embodiments of the present invention have been described above, it is understood that those skilled in the art may make various changes and modifications to the present invention without departing from the spirit and scope of the present invention set forth in the claims below.

According to an aspect, there is provided a vehicle of an electric charging type, including an input/output interface and a processor configured to receive a target driving distance of the vehicle through the input/output interface, compare the target driving distance with a distance to empty (DTE) of the vehicle to determine a necessity of changing an operating intensity of an air conditioning device of the vehicle, and output a determined result through the input/output interface.

In the vehicle according to some aspects, the processor may determine the necessity of changing the operating intensity based on at least one of a minimum rotational speed due to characteristics of the air conditioning device, the target driving distance, the DTE, and a current rotational speed of the air conditioning device.

In the vehicle according to some aspects, the processor may determine that a reduction in the operating intensity is necessary when the DTE is equal to or greater than a first value, a difference between the target driving distance and the DTE is less than a second value, and the current rotational speed of the air conditioning device is greater than the minimum rotational speed.

In the vehicle according to some aspects, the processor may be configured to reduce the operating intensity of the air conditioning device by a first output and calculate a first additional driving distance according to the reduction by the first output and output a request for reducing the operating intensity by the first output through the input/output interface when a difference between the calculated first additional driving distance and the target driving distance is equal to or greater than a third value.

In the vehicle according to some aspects, the processor may be configured to reduce the operating intensity of the air conditioning device by a second output greater than the first output and calculate a second additional driving distance according to the reduction by the second output when the difference between the first additional driving distance and the target driving distance is less than the third value, and output a request for reducing the operating intensity by the second output through the input/output interface when a difference between the calculated second additional driving distance and the target driving distance is equal to or greater than the third value.

In the vehicle according to some aspects, the processor may output a turn-off request of the air conditioning device through the input/output interface when the current rotational speed of the air conditioning device is equal to the minimum rotational speed.

In the vehicle according to some aspects, the processor may output a charging request of the vehicle through the input/output interface when the current rotational speed of the air conditioning device is not detected.

In the vehicle according to some aspects, the processor may reduce the current rotational speed of the air conditioning device in response to a user input requesting a change in the operating intensity or automatically.

In the vehicle according to some aspects, the processor may reduce the current rotational speed of the air conditioning device to the minimum rotational speed.

In the vehicle according to some aspects, the processor may output at least one of the target driving distance and the DTE through the input/output interface to be distinguished from each other.

According to another aspect, there is provided a method of controlling an energy saving mode in a vehicle of an electric charging type, including receiving a target driving distance of the vehicle through an input/output interface of the vehicle, comparing the target driving distance with a distance to empty (DTE) of the vehicle and determining a necessity of changing an operating intensity of an air conditioning device of the vehicle, and outputting a determined result through the input/output interface.

In the method according to some aspects, in the determining of the necessity of changing the operating intensity, the necessity of changing the operating intensity may be determined based on at least one of a minimum rotational speed due to characteristics of the air conditioning device, the target driving distance, the DTE, and a current rotational speed of the air conditioning device.

In the method according to some aspects, in the determining of the necessity of changing the operating intensity, it may be determined that a reduction in the operating intensity is necessary when the DTE is equal to or greater than a first value, a difference between the target driving distance and the DTE is less than a second value, and the current rotational speed of the air conditioning device is greater than the minimum rotational speed.

In the method according to some aspects, in the determining of the necessity of changing the operating intensity, the operating intensity of the air conditioning device may be reduced by a first output and a first additional driving distance is calculated according to the reduction by the first output, and in the outputting of the determined result through the input/output interface, a request for reducing the operating intensity by the first output may be output through the input/output interface when a difference between the calculated first additional driving distance and the target driving distance is equal to or greater than a third value.

In the method according to some aspects, in the determining of the necessity of changing the operating intensity, the operating intensity of the air conditioning device may be reduced by a second output greater than the first output, and a second additional driving distance may be calculated according to the reduction by the second output when the difference between the first additional driving distance and the target driving distance is less than the third value, and in the outputting of the determined result through the input/output interface, a request for reducing the operating intensity by the second output may be output through the input/output interface when a difference between the calculated second additional driving distance and the target driving distance is equal to or greater than the third value.

In the method according to some aspects, in the outputting of the determined result through the input/output interface, a turn-off request of the air conditioning device may be output through the input/output interface when the current rotational speed of the air conditioning device is equal to the minimum rotational speed.

In the method according to some aspects, in the outputting of the determined result through the input/output interface, a charging request of the vehicle may be output through the input/output interface when the current rotational speed of the air conditioning device is not detected.

The method according to some aspects may further include reducing the current rotational speed of the air conditioning device in response to a user input requesting a change in the operating intensity or automatically.

In the method according to some aspects, in the reducing of the current rotational speed of the air conditioning device, the current rotational speed of the air conditioning device may be reduced to the minimum rotational speed.

The method according to some aspects may further include outputting at least one of the target driving distance and the DTE through the input/output interface to be distinguished from each other.

What is claimed is:

1. A vehicle comprising:
a battery;
a motor configured to receive power from the battery;
an air conditioner configured to receive power from the battery;
a user interface;
a processor; and
a memory storing at least one instruction, wherein the at least one instruction, executed by the processor, is configured to cause the vehicle to:
determine, based on a user input received via the user interface, a target driving distance of the vehicle, wherein the user input indicates a destination of the vehicle,
identify a distance to empty (DTE) of the vehicle,
compare the target driving distance with the DTE of the vehicle,
change, based on the comparison of the target driving distance with the DTE of the vehicle, an operating intensity of the air conditioner, and
output, via the user interface, an indication of the changed operating intensity.

2. The vehicle of claim 1, wherein the at least one instruction, executed by the processor, is configured to cause the vehicle to change the operating intensity based on at least one of:
a minimum rotational speed, of the air conditioner, associated with characteristics of the air conditioner;
the target driving distance;
the DTE; or
a current rotational speed of the air conditioner.

3. The vehicle of claim 2, wherein the at least one instruction, executed by the processor, is configured to cause the vehicle to determine a reduction in the operating intensity based on:
the DTE being equal to or greater than a first value, a difference between the target driving distance and the DTE being less than a second value, and the current rotational speed of the air conditioner being greater than the minimum rotational speed.

4. The vehicle of claim 3, wherein the at least one instruction, executed by the processor, is configured to cause the vehicle to:
reduce the operating intensity of the air conditioner by a first output and calculate a first additional driving distance according to the reduction by the first output; and
output, based on a difference between the first additional driving distance and the target driving distance being equal to or greater than a third value, a request for reducing the operating intensity by the first output via the user interface.

5. The vehicle of claim 3, wherein the at least one instruction, executed by the processor, is configured to cause the vehicle to:
reduce the operating intensity of the air conditioner by a first output and calculate a first additional driving distance according to the reduction by the first output;
based on a difference between the first additional driving distance and the target driving distance being less than a third value, reduce the operating intensity of the air conditioner by a second output and calculate a second additional driving distance according to the reduction by the second output, wherein the second output is greater than the first output; and
output, based on a difference between the second additional driving distance and the target driving distance being equal to or greater than the third value, a request for reducing the operating intensity by the second output via the user interface.

6. The vehicle of claim 2, wherein the at least one instruction, executed by the processor, is configured to cause the vehicle to output, based on the current rotational speed of the air conditioner being equal to the minimum rotational speed, a request to turn off the air conditioner via the user interface.

7. The vehicle of claim 2, wherein the at least one instruction, executed by the processor, is configured to cause the vehicle to output, based on the current rotational speed of the air conditioner not being detected, a request to charge the vehicle via the user interface.

8. The vehicle of claim 2, wherein the at least one instruction, executed by the processor, is configured to cause the vehicle to reduce the current rotational speed of the air conditioner in response to a user input requesting a change in the operating intensity or automatically reduce the current rotational speed of the air conditioner.

9. The vehicle of claim 8, wherein the at least one instruction, executed by the processor, is configured to cause the vehicle to reduce the current rotational speed of the air conditioner to the minimum rotational speed.

10. The vehicle of claim 1, further comprising:
at least one sensor,
wherein the at least one instruction, executed by the processor, is configured to cause the vehicle to determine the target driving distance of the vehicle further based on a location of the vehicle detected via the at least one sensor,
wherein the at least one instruction, executed by the processor, is configured to cause the vehicle to identify, based on a state of charge (SOC) of the battery, the DTE, and
wherein the at least one instruction, executed by the processor, is configured to cause the vehicle to output, via the user interface, an indicator of the target driving distance and an indicator of the DTE that is visually distinguished from the indicator of the target driving distance.

11. A method performed by a vehicle, the method comprising:
determining, based on a location of the vehicle detected via at least one sensor of the vehicle and based on a user input received via a user interface of the vehicle, a target driving distance of the vehicle;
identifying, based on a state of charge (SOC) of a battery of the vehicle, a distance to empty (DTE) of the vehicle;
comparing the target driving distance with the DTE of the vehicle;
changing, based on the comparing of the target driving distance with the DTE of the vehicle, an operating intensity of an air conditioner of the vehicle by sending a control signal to the air conditioner; and
outputting, via the user interface, an indication of the changed operating intensity.

12. The method of claim 11, wherein the changing of the operating intensity is determined based on at least one of:
a minimum rotational speed, of the air conditioner, associated with characteristics of the air conditioner;
the target driving distance;
the DTE; or
a current rotational speed of the air conditioner.

13. The method of claim 12, wherein the changing of the operating intensity comprises: determining a reduction in the operating intensity based on:
the DTE being equal to or greater than a first value, a difference between the target driving distance and the DTE being less than a second value, and the current rotational speed of the air conditioner being greater than the minimum rotational speed.

14. The method of claim 13, wherein the changing of the operating intensity comprises:
reducing the operating intensity of the air conditioner by a first output and calculating a first additional driving distance according to the reduction by the first output; and
wherein the method further comprises: outputting, based on a difference between the first additional driving distance and the target driving distance being equal to or greater than a third value, a request for reducing the operating intensity by the first output via the user interface.

15. The method of claim 13, wherein the changing of the operating intensity comprises:
reducing the operating intensity of the air conditioner by a first output and calculating a first additional driving distance according to the reduction by the first output; and
based on a difference between the first additional driving distance and the target driving distance being less than a third value, reducing the operating intensity of the air conditioner by a second output and calculating a second additional driving distance according to the reduction by the second output, wherein the second output is greater than the first output; and
the method further comprises: outputting, based on a difference between the second additional driving distance and the target driving distance being equal to or greater than the third value, a request for reducing the operating intensity by the second output via the user interface.

16. The method of claim 12, further comprising:
outputting, based on the current rotational speed of the air conditioner being equal to the minimum rotational speed, a request to turn off the air conditioner via the user interface.

17. The method of claim 12, further comprising:
outputting, based on the current rotational speed of the air conditioner not being detected, a request to charge the vehicle via the user interface.

18. The method of claim 12, further comprising reducing the current rotational speed of the air conditioner in response to a user input requesting a change in the operating intensity or automatically reducing the current rotational speed of the air conditioner.

19. The method of claim 18, wherein the reducing of the current rotational speed of the air conditioner comprises: reducing the current rotational speed of the air conditioner to the minimum rotational speed.

20. A vehicle comprising:
at least one sensor;
a battery;
a motor configured to receive power from the battery;
an air conditioner configured to receive power from the battery;
a user interface;
a processor; and
a memory storing at least one instruction, wherein the at least one instruction, executed by the processor, is configured to cause the vehicle to:
determine, based on a location of the vehicle detected via the at least one sensor and based on a user input received via the user interface, a target driving distance of the vehicle, wherein the user input indicates a destination of the vehicle,
identify, based on a state of charge (SOC) of the battery, a distance to empty (DTE) of the vehicle,
compare the target driving distance with the DTE of the vehicle, and
change, based on the comparison of the target driving distance with the DTE of the vehicle, an operating intensity of the air conditioner by sending a control signal to the air conditioner.
